(19) United States
(12) Patent Application Publication
(10) Pub. No.: US 2004/0203270 A1
(43) Pub. Date: Oct. 14, 2004

(54) Protective cover and electric outlet arrangement

(76) Inventor: Ming-Shan Wang, TaoYuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/409,566

(22) Filed: Apr. 9, 2003

(51) Int. Cl. H01R 13/44

(52) U.S. Cl. 439/136; 439/145

(57) ABSTRACT

A protective cover and electric outlet arrangement includes a socket unit formed in an outlet body, the socket body having a top recess surrounded by a vertical top peripheral wall thereof, a set of insertion slots formed in the top recess for receiving an electric plug, and a sliding slot formed in the top recess, and a protective cover coupled to the sliding slot and movable along the vertical top peripheral wall to close/open the insertion slots of the socket unit, the protective cover having a bottom guide rod inserted through the sliding slot to guide movement of the protective cover along the sliding slot, the bottom guide rod having an expanded head located on a bottom end thereof and stopped below the sliding slot.

### BACKGROUND OF THE INVENTION

1. Field of the Invention

The present invention relates generally to electric sockets and, more specifically, to a protective cover and electric outlet arrangement, in which the protective cover is positively movably secured to the corresponding socket unit and, can smoothly be moved along a vertical top peripheral wall to close/open the corresponding socket unit.

2. Description of the Related Art

In order to protect an electric outlet from touch of children, a protective cover may be used to close each socket unit in vacant. FIG. 1 illustrates an electric outlet 1 constructed according to the prior art. This structure of electric outlet 1 comprises a plurality of socket units 11 connected in series, and a plurality of protective covers 12 for selectively closing the socket units 11. Because the protective covers 12 are small members detachably fastened to the socket units 11 by a plug joint, they must be carefully received in place when removed from the electric outlet 1.

FIGS. 2A, 2B and 2C show still another prior art design. According to this design, the electric outlet 2 has a transversely extended top recess 22 in each socket unit 21, and the protective cover 23 has two guide rods 231 projected from two sides thereof and respectively coupled to two sliding grooves 221 in two sides of the top recess 22. The protective cover 23 can be moved along the sliding grooves 221 leftwards/rightwards to close/open the positive pole and negative pole insertion holes of the corresponding socket unit 21. This design is not satisfactory in function. Because the protective cover is defined to move in a straight way, a child can easily move the protective cover from the close position to the open position. Further, the protective cover tends to be forced out of the top recess of the corresponding socket unit when moved with the fingers.

FIGS. 3A, 3B and 3C show still another prior art design. According to this design, each socket unit 31 of the electric outlet 3 has a top recess 32 and two hook holes 321 in the top recess 32 at two sides, and the protective cover 33 has two bottom hooks 331 respectively hooked in the hook holes 321 to guide movement of the protective cover 33 along the top recess 32 between the close position and the open position. This design has similar drawbacks as the prior art design shown in FIGS. 2A-2C.

Therefore, it is desirable to provide a protective cover and electric outlet arrangement that eliminates the aforesaid drawbacks.

### SUMMARY OF THE INVENTION

The present invention has been accomplished under the circumstances in view. It is the main object of the present invention to provide a protective cover and electric outlet arrangement, which guides the protective cover to move along a curved path to close/open the corresponding socket unit. It is another object of the present invention to provide a protective cover and electric outlet arrangement, which enables the user to check the position of the protective cover easily with the eyes. It is still another object of the present invention to provide a protective cover and electric outlet arrangement, which prohibits the protective cover from falling out of the corresponding socket unit.

According to the present invention, the protective cover and electric outlet arrangement comprises an outlet body, the outlet body comprising a socket unit, the socket unit having a plurality of insertion holes adapted to receive an electric plug; a protective cover coupled to the outlet body and moved relative to the socket unit to close/open the insertion holes of the socket unit, the protective cover having a plurality of insertion slots corresponding to the insertion slots of the socket unit; wherein the socket unit comprises a vertical top peripheral wall, which surrounds the insertion slots of the socket unit, a top recess defined within the vertical top peripheral wall, and a sliding slot adapted to guide movement of the protective cover along the vertical top peripheral wall to close/open the insertion slots of the socket unit; the protective cover has a bottom guide rod vertically downwardly extended from a bottom side thereof and inserted through the sliding slot to guide movement of the protective cover along the sliding slot, the bottom guide rod having an expanded head located on a bottom end thereof and stopped below the sliding slot.

### BRIEF DESCRIPTION OF THE DRAWINGS

FIG. 1 is an exploded view of a protective cover and electric outlet arrangement according to the prior art.

FIG. 2A is an exploded view of still another design of protective cover and electric outlet arrangement according to the prior art.

FIG. 2B is a schematic drawing shown an application of the design of FIG. 2A.

FIG. 2C is similar to FIG. 2B but showing the electric plug installed.

FIG. 3A is an exploded view of still another design of protective cover and electric outlet arrangement according to the prior art.

FIG. 3B is a sectional view in an enlarged scale of a part of the protective cover and electric outlet arrangement shown in FIG. 3A before positioning of the protective cover.

FIG. 3C is an assembly view of FIG. 3B.

FIG. 4 is an elevational view of an electric outlet constructed according to the present invention.

FIG. 5 is an exploded view in an enlarged view of a part of FIG. 4.

FIG. 6A is a sectional view taken along line 6A-6A of FIG. 5.

FIG. 6B is similar to FIG. 6A but showing an alternate form of the bottom guide rod of the protective cover.

FIG. 6C is similar to FIG. 6A but showing another alternate form of the bottom guide rod of the protective cover.

FIG. 7 is a top view of FIG. 4.

FIG. 8 is a schematic drawing showing still another alternate form of the present invention in which the protective cover is movable along a zigzag path.

FIG. 9 is a schematic drawing showing still another alternate form of the present invention in which the protective cover is movable along a U-turn path.

FIG. 10 is a top view of still another alternate form of the present invention.

FIG. 11A is similar to FIG. 6A but showing an alternate arrangement of the vertical top peripheral wall.

FIG. 11B is similar to FIG. 6B but showing an alternate arrangement of the vertical top peripheral wall.

FIG. 11C is similar to FIG. 6C but showing an alternate arrangement of the vertical top peripheral wall.

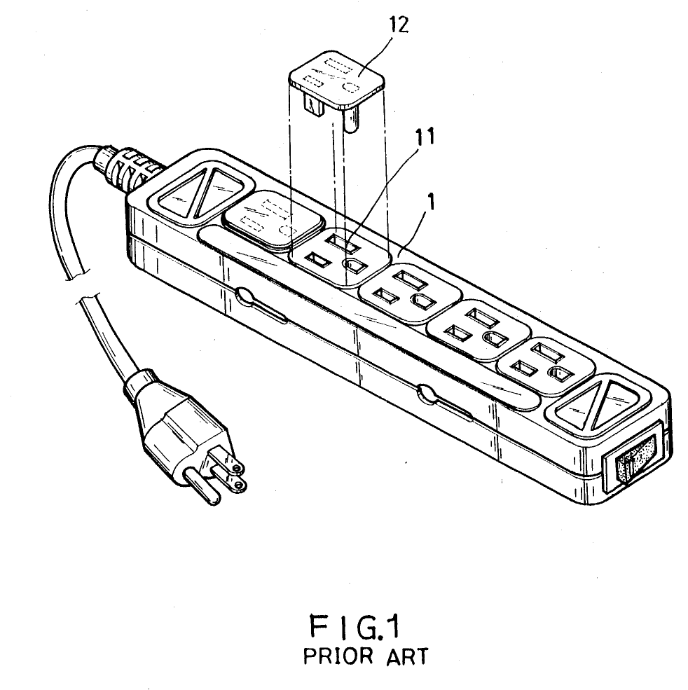

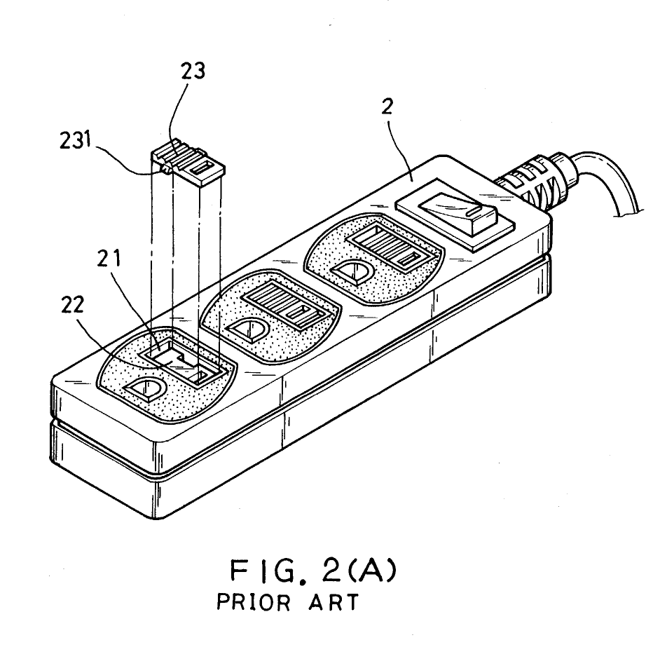

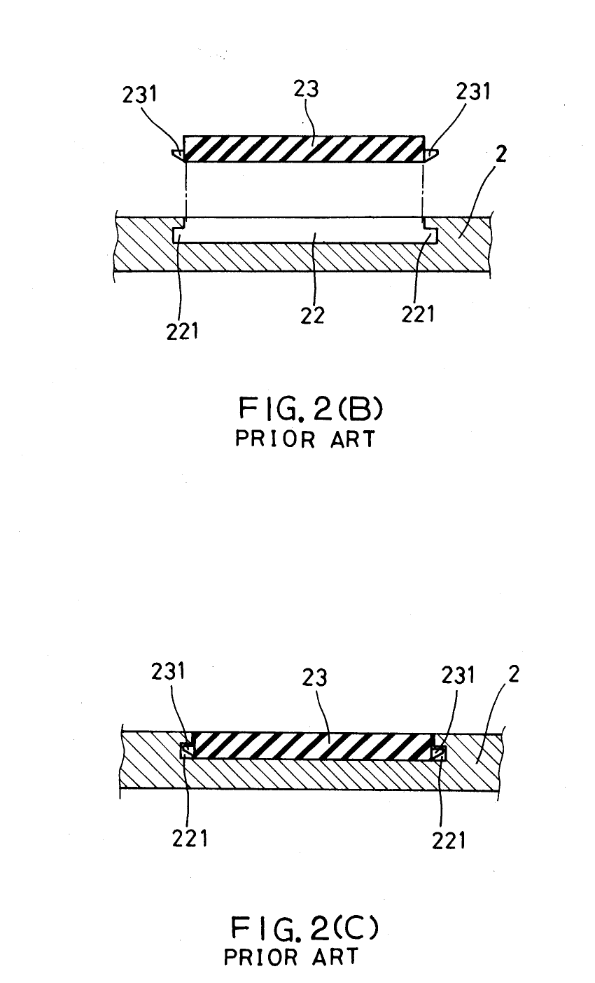

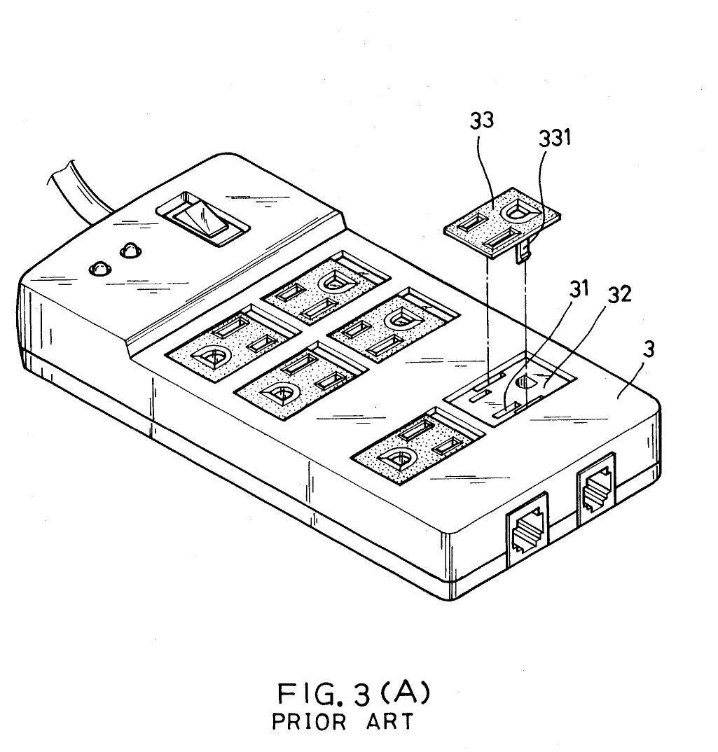

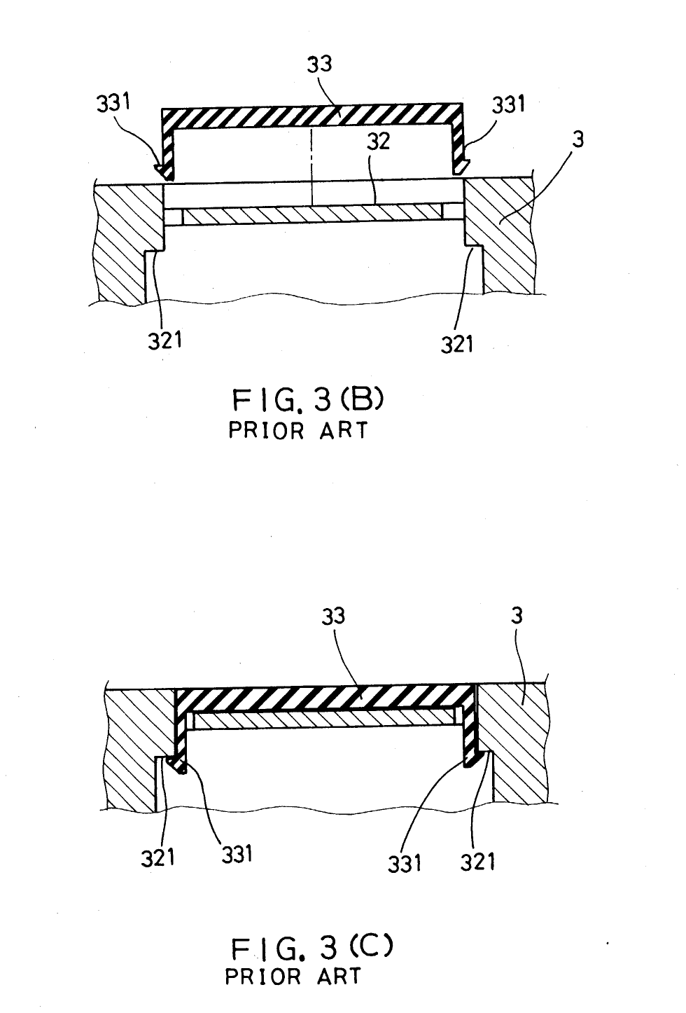

### DETAILED DESCRIPTION OF THE INVENTION

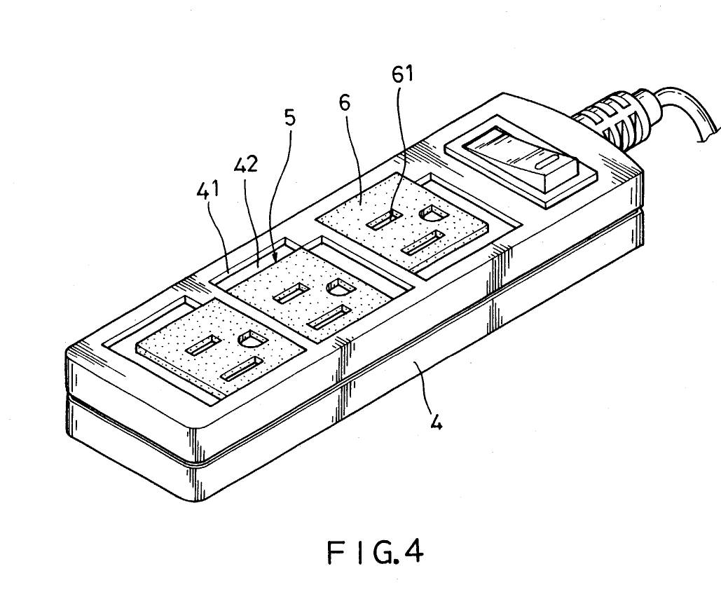

As shown in FIGS. 4 and 5, a protective cover and electric outlet arrangement in accordance with the present invention is shown comprising an outlet body 4. The outlet body 4 comprises at least one socket unit 5. Each socket unit 5 has a plurality of insertion slots 51 in the top wall for receiving an electric plug. Each socket unit 3 is covered with a respective cover 6, which has a plurality of insertion slots 61 corresponding to the insertion slots 51 of the socket unit 5. The protective cover 6 can be moved to close/open the insertion slots 51 of the corresponding socket unit 5.

Referring to FIG. 5 again, the socket unit 5 has a vertical top peripheral wall 41 defining a top recess 42, which receives the protective cover 6, an angled sliding slot 52 in the top recess 42, and a through hole 521 in the top recess 42 in communication with one end of the angled sliding slot 52. The angled sliding slot 52 has The protective cover 6 is smaller than the top recess 42, and movable along the vertical top peripheral wall 41 within the top recess 42. The protective cover 6 has a bottom guide rod 62, which is inserted through the through hole 521 and movable with the protective cover 6 along the angled sliding slot 52. The bottom guide rod 62 has a bottom end terminating in an expanded head 63, which has a diameter smaller than the through hole 521 but greater than the width of the angled sliding slot 52.

Referring to FIG. 6A and FIGS. 4 and 5 again, the bottom guide rod 62 is inserted through the through hole 521 and moved into the angled sliding slot 52, keeping the expanded head 63 stopped below the bottom side of the angled sliding slot 52. According to the present invention, the bottom guide rod 62 and the protective cover 6 are molded from plastics in integrity. When the bottom guide rod 62 inserted into the angled sliding slot 52 and the protective cover 6 forced into the top recess 42, the left side 65 of the protective cover 6 is abutted against one side of the vertical top peripheral wall 41, prohibiting backward movement of the bottom guide rod 62 with the protective cover 6 along the angled sliding slot 52 to the through hole 521, and therefore the protective cover 6 is constrained to move within the top recess 42 and will never fall out of the socket unit 5.

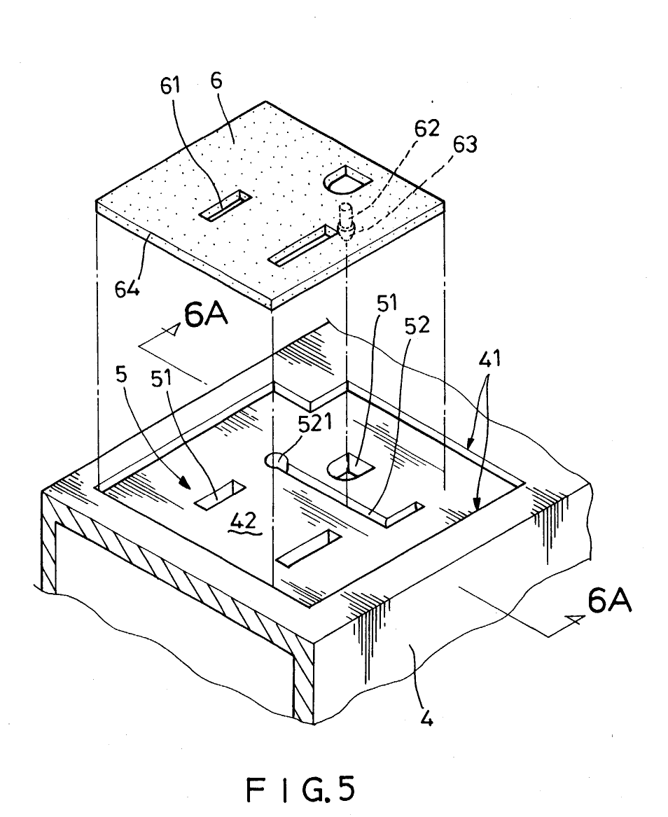

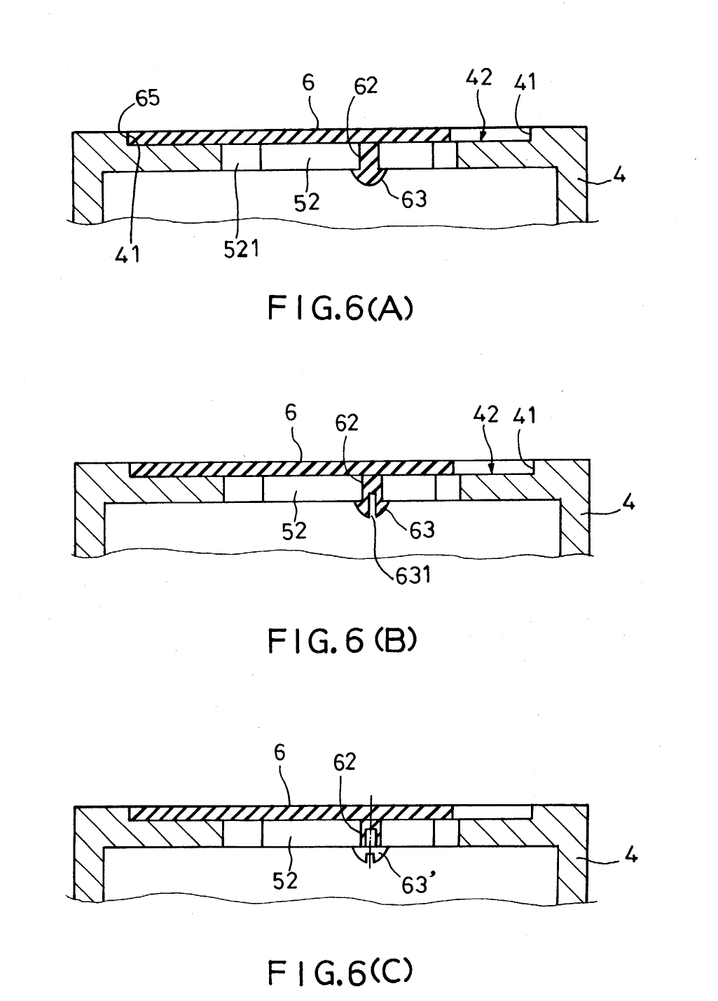

FIG. 6B shows an alternate form of the present invention. This embodiment is similar to the embodiment shown in FIG. 6A with the reception of the structure of the bottom guide rod 62. According to this embodiment, the bottom guide rod 62 is a split rod having a split 631 in the expanded head 63.

FIG. 6C shows another alternate form of the present invention. According to this embodiment, the bottom guide rod 62 is formed of a round head screw 63′ fastened to the bottom side of the protective cover 6.

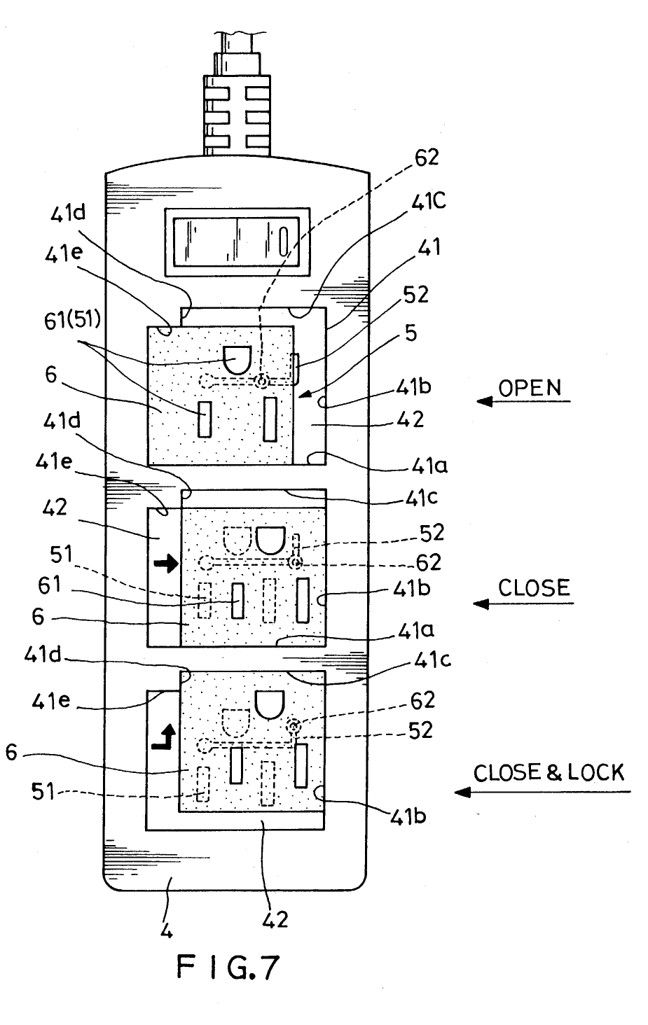

FIG. 7 is a top view in an enlarged scale of FIG. 4, showing OPEN, CLOSE, CLOSE&LOCK positions of respective protective covers in respective socket units. The protective cover 6 at the top side in FIG. 7 is moved to OPEN position and abutted against the left side of the vertical top peripheral wall 41 of the corresponding socket unit 5, and the insertion slots 61 of the protective cover 6 are respectively aimed at the insertion slots 51 of the socket unit 5 for the mounting of an electric plug; the middle protective cover 6 shown in FIG. 7 is moved rightwards along the bottom guide face 41a and transversely extended upper guide face 41e of the vertical top peripheral wall 41 of the corresponding socket unit 5 to CLOSE position and abutted against the right side 41b of the vertical top peripheral wall 41 of the corresponding socket unit 5, prohibiting the insertion of an electric plug or external body into the corresponding socket unit 5; the protective cover 6 at the bottom side in FIG. 7 is moved upwards along the right guide face 41b and left longitudinal guide face 41d of the vertical top peripheral wall 41 of the corresponding socket unit 5 to CLOSE&LOCK position and abutted against the top guide face 41c of the vertical top peripheral wall 41 of the corresponding socket unit 5. When moved to CLOSE&LOCK position, the bottom guide rod 62 is shifted from the transverse section of the angled sliding slot 52 into the longitudinal section thereof, and therefore the protective cover 6 is prohibited from leftward movement.

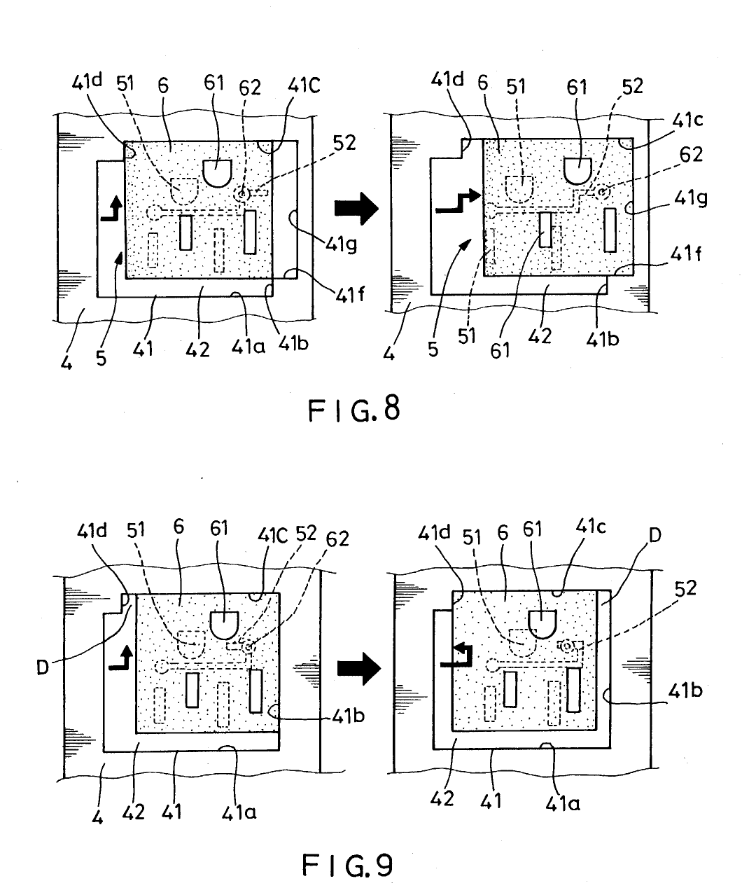

FIG. 8 shows still another alternate form of the present invention. According to this embodiment, the sliding slot 52 is a zigzag sliding slot; the vertical top peripheral wall 41 of the corresponding socket unit 5 further comprises a transversely extended lower guide face 41f and a right longitudinal guide face 41g connected in series between the top end of the right guide face 41b and the right end of the top guide face 41c for guiding the bottom guide rod 62 of the protective cover 6 along the zigzag sliding slot 52.

FIG. 9 shows still another alternate form of the present invention. According to this embodiment, the sliding slot 52 is a U-turn sliding slot; the length of the top guide face 41C is longer than the transverse width of the protective cover 6 so that a gap D is left when the protective cover 6 abutted against the right guide face 41b, and the protective cover 6 can be moved rightwards along the top guide face 41c after touched the right guide face 41b.

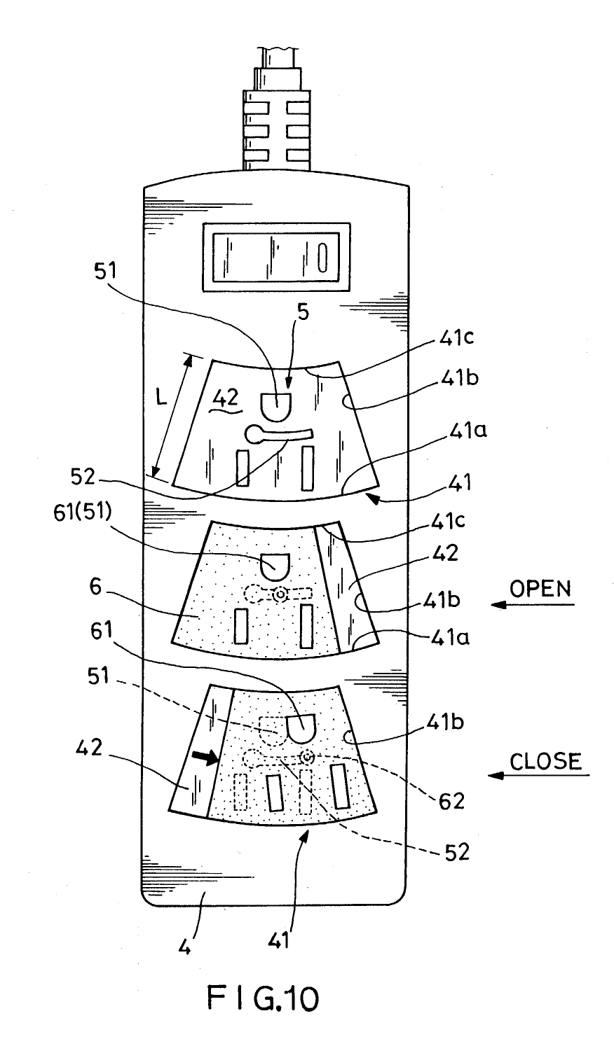

FIG. 10 shows still another alternate form of the present invention. According to this embodiment, the top recess 42 has a sector-like profile; the top guide face 41c and bottom guide face 41a of the vertical top peripheral wall 41 of the corresponding socket unit 5 are smoothly arched and arranged in parallel; the sliding slot 52 is an elongated, smoothly arched sliding slot; the protective cover 6 is a sector-like cover having a longitudinal length fitting the height L between the top guide face 41c and bottom guide face 41a of the vertical top peripheral wall 41 of the corresponding socket unit 5. According to this design, the respective socket unit 5 is opened when the protective cover 6 moved along the sliding slot 52 to the left side; the respective socket unit 5 is closed when the protective cover 6 moved along the sliding slot 52 to the right side.

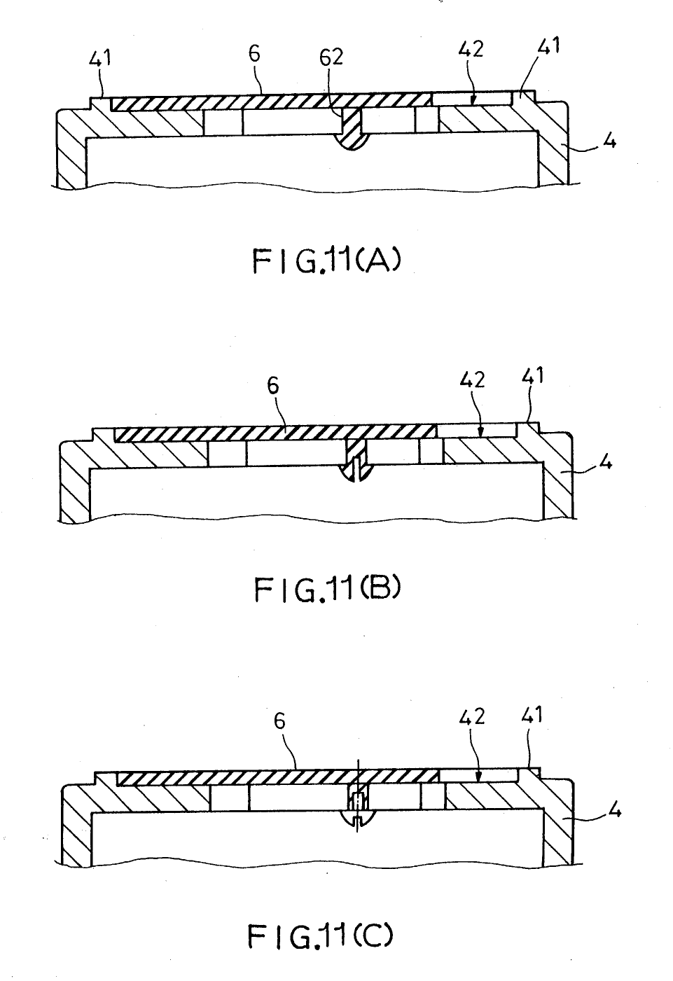

FIGS. 11A˜11C show further alternate forms of the present invention. These alternate forms are respectively similar to the embodiments shown in FIGS. 6A˜6C with the exception of the vertical top peripheral wall 41. According to the embodiments shown in FIGS. 6A˜6C, the vertical top peripheral wall 41 is disposed in flush with the top surface of the outlet body 4. According to the embodiments shown in FIGS. 11A˜11C, the vertical top peripheral wall 41 protrudes over the top surface of the outlet body 4.

As indicated above, the present invention provides a protective cover and electric outlet arrangement in which the protective cover is guided by the vertical top peripheral wall of the corresponding socket unit to move along a sliding slot in the corresponding socket unit between different positions to close/open the corresponding socket unit.

A prototype of protective cover and electric outlet arrangement has been constructed within the features of FIGS. 4˜11. The protective cover and electric outlet arrangement functions smoothly to provide all the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A protective cover and electric outlet arrangement comprising:
an outlet body, said outlet body comprising a socket unit, said socket unit having a plurality of insertion holes adapted to receive an electric plug;
a protective cover coupled to said outlet body and moved relative to said socket unit to close/open the insertion holes of said socket unit, said protective cover having a plurality of insertion slots corresponding to the insertion slots of said socket unit;
wherein said socket unit comprises a vertical top peripheral wall, which surrounds the insertion slots of said socket unit, a top recess defined within said vertical top peripheral wall, and a sliding slot adapted to guide movement of said protective cover along said vertical top peripheral wall to close/open the insertion slots of said socket unit; said protective cover has a bottom guide rod vertically downwardly extended from a bottom side thereof and inserted through said sliding slot to guide movement of said protective cover along said sliding slot, said bottom guide rod having an expanded head located on a bottom end thereof and stopped below said sliding slot.

2. The protective cover and electric outlet arrangement as claimed in claim 1, wherein said sliding slot is a linear sliding slot.

3. The protective cover and electric outlet arrangement as claimed in claim 1, wherein said sliding slot is an angled sliding slot.

4. The protective cover and electric outlet arrangement as claimed in claim 1, wherein said sliding slot is a zigzag sliding slot.

5. The protective cover and electric outlet arrangement as claimed in claim 1, wherein said sliding slot is a smoothly arched sliding slot.

6. The protective cover and electric outlet arrangement as claimed in claim 1, wherein said expanded head is formed integral with said bottom guide rod.

7. The protective cover and electric outlet arrangement as claimed in claim 1, wherein said bottom guide rod and said expanded head are formed of a screw fastened to said protective cover.

8. The protective cover and electric outlet arrangement as claimed in claim 1, wherein said vertical top peripheral wall of said socket unit is disposed in flush with a top surface of said outlet body.

9. The protective cover and electric outlet arrangement as claimed in claim 1, wherein said vertical top peripheral wall of said socket unit protrudes over a top surface of said outlet body.
